(19) United States
(12) Patent Application Publication
(10) Pub. No.: US 2012/0136698 A1
(43) Pub. Date: May 31, 2012

(54) Barcode enabled coupon search, retrieval, presentation and redemption via telecommunications devices

(76) Inventor: Carl E. Kent, Shakopee, MN (US)

(21) Appl. No.: 13/150,880

(22) Filed: Jun. 1, 2011

Related U.S. Application Data
(60) Provisional application No. 61/396,718, filed on Jun. 2, 2010.

(51) Int. Cl. G06Q 30/02

(52) U.S. Cl. 705/14.1

(57) ABSTRACT

Methods and systems for barcode enabled coupon search, retrieval, presentation, and redemption via telecommunications devices. One system includes using a mobile phone camera to scan product barcodes and retrieve a matching coupon. The system further includes a coupon server that supplies coupon matching bar coder search request, along with supplying and displaying competing sponsor coupons alongside user's primary product coupon. The system further includes the presentation and redemption of said coupon on mobile devices. The system further includes real-time sharing of barcode retrieved coupons with users friends on internet Websites. Finally, the system includes the production of data analytics to predict user shopping habits.

### CROSS-REFERENCE TO RELATED APPLICATION

The present patent application claims the benefit of a provisional patent application Ser. No. 61/396,718 filed Jun. 2, 2011 and entitled “Barcode enabled coupon search, retrieval, presentation and redemption via telecommunications devices.

### STATEMENT REGARDING FEDERALLY SPONSORED RESEARCH AND DEVELOPMENT

Not applicable.

### TECHNICAL FIELD

The present disclosure relates generally to coupon gathering and delivery systems related to telecommunications devices. Specifically, the present disclosure relates to methods and systems for barcode enabled coupon search, retrieval, presentation, and redemption via telecommunications devices.

### BACKGROUND

Coupons, most-typically for use in retail sales, are a marketing tool for introducing new products to the marketplace, introducing new customers to a product, or to otherwise stimulate interest in a product. Various types of coupons, including discount, special-offer, rebate coupons, and the like, are a common marketing strategy, particularly for consumer goods and food items that are typically sold at groceries, drug stores, and discount stores. Product sellers and manufacturers use coupons to introduce new products, promote new and existing products, and increase sales. One highly useful characteristic of a coupon system is the capability of obtaining demographic information of consumer buying patterns.

Although coupon systems have many positive attributes, improvements are possible. Businesses continually seek improvements in operating costs. Coupons are commonly placed as advertisements in direct mailings, newspapers, magazines, and the like. Costs to product manufacturers and sellers are commonly substantial for coupon advertising placements.

Paper coupons are expensive to produce, even more expensive to distribute, and fail to produce a rapid response in the marketplace. User discovery and immediacy of access to coupons is also a source of significant problems with prior inventions. With both paper and the advent of online coupons, users must engage in pre-shopping planning to search, match, and clip and/or print paper coupons before visiting retailers. Under prior art methods, if the user/shopper forgets to conduct pre-shopping planning, s/he fails to get corresponding product discounts, adding up to loss of significant financial resources and lost sales for retailers.

On the subject of coupon search, many systems currently exist which use an input to access different online resources. The most common example of such a system is a search engine such as Yahoo, Google, AltaVista, etc. Search engines allow users to search one or more databases using different combinations of search terms and Boolean connectors. The results are usually displayed in a list form, with the most relevant results at the top of the list. These search engines provide quick access to information. However, using such systems it is often difficult to access specific information. For example, if a user is looking for information on a particular person or product type, the search engine will return every instance of the search term. It may take the user a long period of time to sift through the information and find the specific link or information the user was looking for.

Recently, search engines have also become available for mobile devices which have Internet access. The user can use the keypad on the mobile device to type in keywords and search the Internet much like a user would on a computer. However, due to the small sized screen and the vast amount of search results, it is usually even more difficult to sift through the results on the mobile device than on a computer.

Simple database systems also currently exist which use an input term to produce one or more outputs. An example of such a system is the barcode scanning terminal and register used at most shopping centers. As the cashier scans the different products in each consumer's shopping cart, the barcode scanning terminal uses a database to associate each barcode with a price, item name, and/or item description. The register then uses this information to compute the total of the purchase. This system allows the checkout process to be extremely streamlined and efficient. However, the database requires much maintenance since every type of item in the store must be included in the database. This can lead to an extremely large database which requires a great deal of maintenance. For example, the database needs to be updated each time the store adds a new item or changes an item's price.

Currently, there are systems available which can be used to link printed barcode information directly to online coupon using barcode scanners. These systems typically function by using the scanner to scan the barcode, connect the scanner to a computer, upload the barcode information to a server, search a barcode database to retrieve information, and send the information back to the mobile device. Since most mobile devices are not associated with an add-on barcode scanner, these systems have not yet been widely adopted. Also, these systems suffer from the burden that each barcode needs to be in the database in order for the system to function.

With the advent of camera phones and other similar mobile devices equipped with digital cameras, technology has been developed to decode barcodes from digital images. For example, a system for decoding barcodes on mobile devices from digital images is disclosed in U.S. patent application Ser. No. 20070063050. This allows camera phones to be used as mobile barcode scanners. Therefore, camera phones can now be utilized with systems which link printed barcode information directly to online coupon.

Printing and distribution costs of coupon advertising campaigns are substantial, commonly with a very low response rate. The low response rate highlights the inefficiency of coupon advertising campaigns and gives evidence of costs, such as disposal and handling costs, that are not directly borne by manufacturers and sellers but are shared among all of society.

Low response rates are further indicative of reluctance of potential customers to expend the effort to use coupons. Usage of coupons is not cost-free to the customer. Many potential customers do not invest the time, space, and other resources to collect, catalogue, store, and retrieve coupons, as well as to manage coupons having various expiration dates. Coupon handling is time-consuming and cumbersome.

Often, only consumers on a strict budget, with excess free time, or who enjoy couponing as a hobby have sufficient time to use coupons. Busy or more affluent consumers often do not consider coupon management to be a cost-effective usage of time. These busy and more affluent consumers represent a more desirable demographic for many product manufacturers and sellers.

Businesses that redeem the coupons bear similar storage, handling, and management costs, including expenditure of valuable employee time for retail store reimbursement. The system of clearing distributed and redeemed coupons involves physically sending redeemed coupons to a clearinghouse. The clearinghouse returns the coupons to the issuer and tallies debits and credits to the manufacturer and retailer. Physical handling of coupons is expensive, cumbersome, error prone, slow and prone to fraud.

Electronic distribution of retail coupons reduces cost in comparison to printed coupons, but require measures to prevent fraud. Proposed fraud prevention systems are either burdensome for the consumer or costly for retailers to implement.

Manufacturers use retail coupons to introduce consumers to new products, as well as to clear distressed inventory. Coupons are generally printed and passed to a distribution company, which either mails the coupons to consumers, or authorizes newspapers to print the coupons. Typical response rates are in the range from 3% to 5% for untargeted coupons, and in the range from 5% to 7% for coupons sent to likely target consumers. The coupons are used by consumers during a retail purchase transaction. A bar code on the coupon is scanned. The coupon is reported for anti-fraud purposes, and the appropriate price reduction is granted to the consumer. A the end of a sales period, typically a month, the retailer presents a report to the manufacturer who compensates the retailer for the coupons redeemed.

Various solutions have been attempted to solve these problems with coupons. One approach is to allow consumers to print their own coupons. This solution reduces distribution costs and latency, but requires the consumer to bring the paper coupon with them while shopping. The solution does not allow for opportunistic shopping, which accounts for the majority of retail purchases. Therefore, there clearly exists a need for a system which links users with mobile devices equipped with a barcode scanner or digital camera to online coupon without the burden of maintaining a large and extensive barcode database. Such a system would allow user's quick and reliable access to online coupons with minimal cost to the issuer and/or retailer.

On the subject of coupon search, many systems currently exist which use an input to access different online resources. The most common example of such a system is a search engine such as Yahoo, Google, AltaVista, etc. Search engines allow users to search one or more databases using different combinations of search terms and Boolean connectors. The results are usually displayed in a list form, with the most relevant results at the top of the list. These search engines provide quick access to information. However, using such systems it is often difficult to access specific information. For example, if a user is looking for information on a particular person or product type, the search engine will return every instance of the search term. It may take the user a long period of time to sift through the information and find the specific link or information the user was looking for.

Recently, search engines have also become available for mobile devices which have Internet access. The user can use the keypad on the mobile device to type in keywords and search the Internet much like a user would on a computer. However, due to the small sized screen and the vast amount of search results, it is usually even more difficult to sift through the results on the mobile device than on a computer.

Simple database systems also currently exist which use an input term to produce one or more outputs. An example of such a system is the barcode scanning terminal and register used at most shopping centers. As the cashier scans the different products in each consumer's shopping cart, the barcode scanning terminal uses a database to associate each barcode with a price, item name, and/or item description. The register then uses this information to compute the total of the purchase. This system allows the checkout process to be extremely streamlined and efficient. However, the database requires much maintenance since every type of item in the store must be included in the database. This can lead to an extremely large database which requires a great deal of maintenance. For example, the database needs to be updated each time the store adds a new item or changes an item's price.

Currently, there are systems available which can be used to link printed barcode information directly to online coupon using barcode scanners. These systems typically function by using the scanner to scan the barcode, connect the scanner to a computer, upload the barcode information to a server, search a barcode database to retrieve information, and send the information back to the mobile device. Since most mobile devices are not associated with an add-on barcode scanner, these systems have not yet been widely adopted. Also, these systems suffer from the burden that each barcode needs to be in the database in order for the system to function.

With the advent of camera phones and other similar mobile devices equipped with digital cameras, technology has been developed to decode barcodes from digital images. For example, a system for decoding barcodes on mobile devices from digital images is disclosed in U.S. patent application Ser. Nos. 20070063050 and 20050011957. These allow camera phones to be used as mobile barcode scanners. Therefore, camera phones can now be utilized with systems which link printed barcode information directly to online coupon.

Therefore, there clearly exists a need for a system which links users with mobile devices equipped with a barcode scanner or digital camera to online coupon without the burden of maintaining a large and extensive barcode database. Such a system would allow user's quick and reliable access to online coupon with minimal cost to the supplier and/or vendor.

For these and other reasons, improvements are desirable.

### SUMMARY

In accordance with the present disclosure, the above and other problems are solved by the following:

In a first aspect, the present invention discloses a system and methods for a barcode enabled coupon search, retrieval, presentation, and redemption via telecommunications devices. The system and methods are used to manage and distribute information scanned from mobile device users to coupon issuers, which include, but are not limited to, retailers, consumer packaged goods (CPG) manufacturers, pharmaceutical manufacturers, distributors, and the like.

In a second aspect, the system utilizes a mobile device equipped with a barcode scanner or digital camera, at least one item with a barcode, a wireless network, a server having a plurality of different databases (e.g., a user database and a vendor database), and a plurality of retailers and/or coupon issuers. The mobile device may be any device capable of transmitting data over the wireless network such as a cell phone, a camera phone, a personal digital assistant, etc.

Barcodes compatible with the present invention are usually found on products or in advertisements. However, it should be apparent to one skilled in the art how the barcode could be any one or two-dimensional barcode from a symbology including, but not limited to, UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and/or proprietary two-dimensional codes.

The wireless network may be any network capable of transmitting information wirelessly between a mobile device and a computer and/or other mobile device. For example, the wireless network could be a cellular network, satellite network, Bluetooth network, Wi-Fi network, etc.

In a third aspect, to use the system, a user first scans the barcode using the mobile device. The user may scan the barcode either using a barcode scanner attached to the mobile device or by using the digital camera attached to or embedded in the device. If the user elects to take a picture of the barcode, it may be decoded optically on the device. A system for decoding barcodes on mobile devices from digital images is disclosed in this application. The user could also decide to take a picture of the barcode and send the snapshot or the raw data constituting the image to the control center to be decoded on a server instead of the handset

In a fourth aspect of the methods disclosed, after the barcode has been decoded, the barcode information and a user identification number are sent to a server, locally or remotely located on an Internet or Internet respectively, via a wireless network. In the case where the barcode is decoded by the server, the user will send the user identification number and either the snapshot or the raw data of the barcode image. The server then uses the transmitted product code and user identification number to look up the matching product coupon using a user database. The server next parses the barcode into its constituent parts if possible. For example, every UPC-A barcode contains a manufacturer code, a product code, and a checksum digit.

In a fifth aspect, the user database associates each product code with a list of available coupons and the server tracks each user search transaction by product code, type, date, user demographic information (previously obtained from the user upon initial service registration). Said tracking is the basis of producing analytics to predict, based on user's barcode scanning history, relevant products for particular profiled shoppers.

In a sixth aspect of methods disclosed, the product code, or other similar identifying information, contained within the barcode information is used to associate the scanned barcode with a list of coupons. As supplemental information presented on the user's mobile device, the server retrieves coupons from competing issuers who have purchased prioritized rights to display their product category coupons alongside the user's primary product coupons. Preferably, this step is accomplished by sending the data to the different coupon issuers' web services via an XML post.

In a seventh aspect of methods disclosed, the user determines whether to complete the purchase and, if so, displays the coupon barcode on the screen display. The user hands the mobile device to a retail clerk so that the barcode is scanned.

In an eighth aspect of the present invention, a communication application executable on a network including a client process executable on a processor in a mobile device, a server process executable on a processor communicatively coupled over the network to the client process; and a coupon depository coupled to the server process capable of storing a plurality of coupons. The mobile device includes a display screen capable of displaying a barcode image suitable for scanning by a barcode scanner. The coupons include an encoding of a barcode image. The server process includes an operation of sending a coupon to the client process. The client process includes an operation for decoding the barcode image encoding and displaying the barcode image on the display screen for scanning by the barcode scanner.

In a ninth aspect of the invention, a communication application is executable on a network communicatively coupled to a server process. The communication application includes a client process executable on a processor in a mobile device. The mobile device includes a display screen capable of displaying a barcode image suitable for scanning by a barcode scanner. The client process includes an interactive input process capable of receiving input signals from the mobile device, a communication initiating process responsive to the input signals for sending application initiation signals to the server process via the network, and a communication receiving process responsive to communication signals from the server process for receiving coupon information from the server process. The coupon information includes an encoded barcode image. The client process further includes a display process responsive to the receipt of coupon information for decoding the encoded barcode image and displaying the barcode image.

In a tenth aspect of the present invention, a communication application executable on a network includes an electronic coupon clearinghouse coupled to the network and containing a plurality of electronic coupons, a coupon database coupled to the electronic coupon clearinghouse; a server coupled to the network, and a mobile device capable of communicating on the network and receiving electronic coupons from the server via the network. The electronic coupons include an encoded barcode image. The server is capable of accessing the electronic coupon clearinghouse and receiving selected electronic coupons from the electronic coupon clearinghouse. The mobile device is capable of decoding the encoded barcode images and displaying the barcode images on a screen display for scanning by a barcode scanner.

In an eleventh aspect of methods disclosed, the present invention enables users to use their mobile device to post to Internet databases, and coupon feeds on Websites such as Twitter, Facebook, MySpace, Orkut, HiS, and the like, coupons retrieved via mobile barcode scan and search for purposes of real-time sharing of said coupons with friends, colleagues, etc.

All publications, patents, and patent applications cited herein are hereby incorporated by reference in their entirety for all purposes.

### BRIEF DESCRIPTION OF THE DRAWINGS

FIG. 1 depicts a system diagram showing the preferred setup of the mobile gateway.

FIG. 2 depicts a flowchart showing the process used by the mobile gateway to provide coupon from retailers or coupon issuers to users.

FIG. 3 is a schematic block diagram that illustrates an example of a retail coupon distribution system.

FIG. 4 is a highly schematic block diagram that illustrates a system for supplying information to a mobile device via the Internet.

FIG. 5 is a pictorial view that shows an example of a cellular telephone screen imposed with a bar-code for usage in various embodiments of the retail distribution apparatus.

FIG. 6 depicts a schematic block diagram of a liquid crystal display (LCD) that is suitable for usage in the retail distribution apparatus.

FIG. 7 is a schematic block diagram illustrating one example of a network and mobile data communication devices that are suitable for usage with the retail coupon distribution system and associated operating method.

FIG. 8 is a highly schematic flow diagram that depicts an example of a communication operation between a mobile device such as a cellular telephone or pager and a servers.

FIG. 9 is a schematic block diagram illustrating an example of a network with mobile data communication devices that includes a network translator.

FIG. 10 is a schematic block diagram showing a mobile wireless communication device and a server in a network architecture that is suitable for usage with the retail coupon distribution system and associated operating method.

### DETAILED DESCRIPTION

The following presents a detailed description of a preferred embodiment (as well as some alternative embodiments) of the present invention. However, it should be apparent to one skilled in the art that the described embodiment may be modified in form and coupon to be optimized for a wide variety of situations.

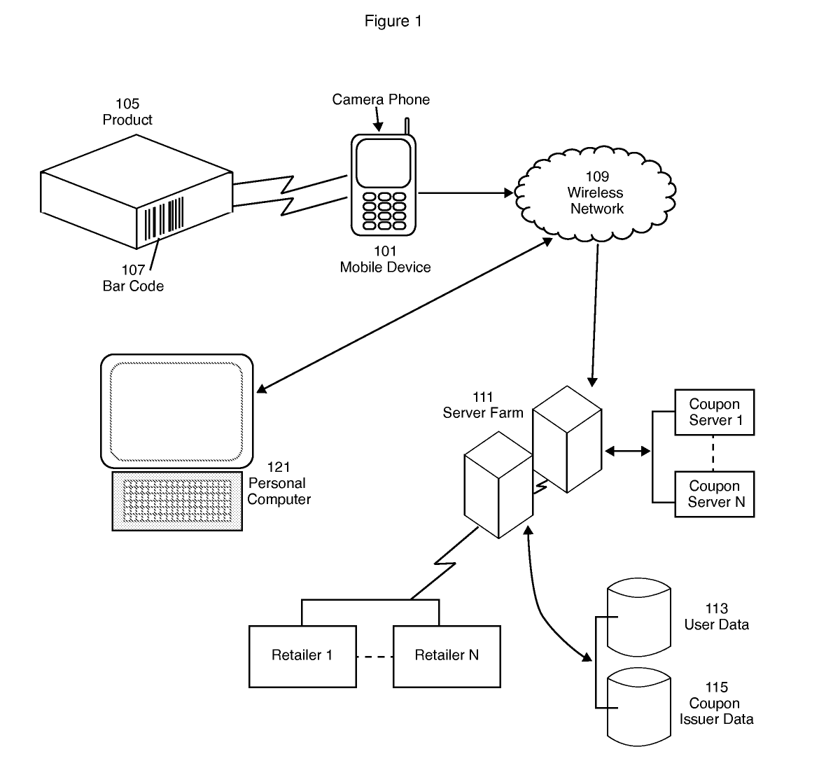

With reference first to FIG. 1, shown is a system diagram depicting the setup of the preferred embodiment of the present invention. To function, the system utilizes mobile device 101 equipped with barcode scanner or a digital camera 103, at least one item 105 with a barcode 107, wireless network 109, server 111, user database 113, coupon issuer database 115, retailers 117a to 117n, and coupon issuers 119a to 119n. Mobile device 101 may be any device capable of transmitting data over wireless network 109 such as a cell phone, a camera phone, a personal digital assistant, a web camera attached to a computer, etc.

Item 105 is preferably a product or other similar item of commerce. However, it should be apparent to one skilled in the art that item 105 may be any object to which a barcode can be attached such as an advertisement, a poster, a ticket, etc. Similarly, barcode 107 could be any one or two-dimensional barcode from a symbology including, but not limited to, UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and any proprietary two-dimensional barcode. Preferably, barcode 107 is a UPC-A barcode which is typically composed of a manufacturer code, an item code, and a check digit.

It should also be obvious to one skilled in the art that barcode 107 could be any machine-readable code, such as an RFID code. This would require only that digital camera 103 be replaced with a RFID reader. The rest of the system could still function utilizing the information decoded from the RFID code.

Wireless network 109 may be any network capable of transmitting information wirelessly between mobile device 101 and server 111. For example, the wireless network could be a cellular network, satellite network, Bluetooth network, Wi-Fi network, etc.

Server 111 is equipped with user database 113 and coupon issuer database 115. User database 113 is a standard database which stores users' identification numbers, preferred retailers, and preferred coupon issuers and is capable of being modified and updated in real-time. Coupon issuer database 115 associates each manufacturer code with a list of categories and retailers and/or coupon issuers.

Retailers 117a-117n may be any one of a plurality of online retailers. Coupon issuers 119a-119n may be any online coupon issuer of production information or media coupon.

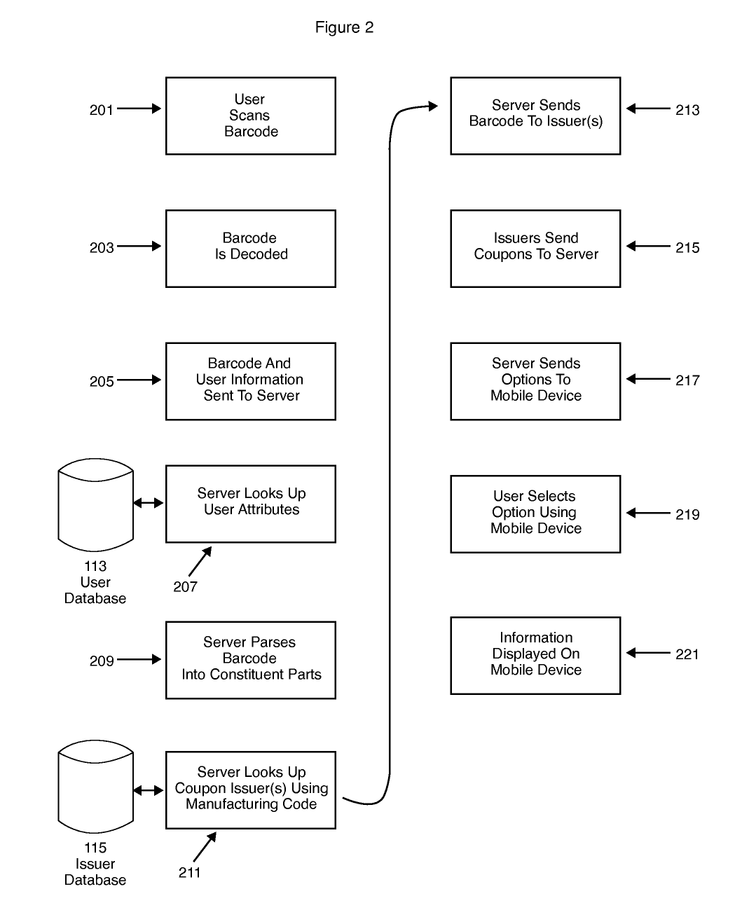

Next referring to FIG. 2, shown is a flowchart depicting the operation of the mobile gateway. To use the mobile gateway of the present invention, a user first scans barcode 107 using barcode scanner 103 attached to mobile device 101 in step 201. Barcode 107 is then decoded in step 203. Barcode 107 may be decoded by barcode scanner 103 in a variety of ways. In the preferred embodiment of the present invention, barcode scanner 103 is a digital camera. A system for decoding barcodes on mobile devices from digital images is disclosed in co-pending U.S. patent application Ser. Nos. 20070063050 and 20050011957. The user could also decide to take a picture of the barcode using barcode scanner 103 and send the snapshot or the raw data constituting the image to the control center to be decoded on server 111 instead of on mobile device 101.

Alternatively, barcode scanner 103 may be a laser-based scanner which is integral to or attached to mobile device 101. Currently, laser-based scanners are the most commonly used barcode scanners. However, they generally lack the versatility of optical barcode scanners and can only usually decode a limited number of barcode symbologies.

After the barcode has been decoded in step 203, the barcode information and a user identification number are sent to server 111 via wireless network 109 in step 205. In the case where the barcode is decoded by server 111, mobile device 101 sends the user identification number and either the snapshot or the raw data of the barcode image. Otherwise, just the decoded barcode number is sent. Server 111 then uses the transmitted user identification number to look up the user's preferred retailers and coupon issuers using user database 113 in step 207. User database 113 associates each user identification number with a list of preferred retailers. The server next parses the barcode into its constituent parts if possible in step 209. This step is generally performed when barcode 107 is a UPC-A barcode comprised of a manufacturer code, a product code, and a checksum digit.

The manufacturer code contained within barcode 107 information is used by server 111 in step 211 to associate item 105 with a list of retailers or coupon issuers using coupon issuer database 115. Server 111 may also associate the manufacturer code with a category of items including, but not limited to, home furnishings, accessories, gifts, curtains/drapes, linens, house wares, china glass and silver, home lighting products, agricultural, farming, floral (non-food), alcoholic beverages, apparel, audio/video, automotive, building supplies, computer hardware, software, food, beverage, food service, furniture, general merchandise, health and beauty products, healthcare, hobbies, crafts, sewing equipment, household and industrial chemicals, lawn and garden products, marine equipment and supplies, market research data, musical instruments, professional sound equipment, sheet music, office and school supplies, stationary, gift wrap, greeting cards, pet food and supplies, home electronics, major appliances, camera, binoculars, telescopes, power transmission, books, magazines, holiday seasonal products, sport and exercise equipment, toys, games, tobacco, packaging materials, electrical components, meat, poultry, seafood, maintenance, repair, raw materials, produce, accessories and leather products, shoes, watches, costume and fine jewelry, industrial, and commercial.

Server 111 then transmits the entire decoded barcode to each of the appropriate retailers 117a-117n and coupon issuers 119a-119m (as identified in step 211) in step 213. Each vendor and coupon issuer returns coupon, a list of options, and/or detailed information to server 111 in step 215. Server 111 then transmits the list of retailers/coupon coupon issuers and/or options or uses the information provided by the retailers/coupon coupon issuers to generate a WAP page on-the-fly by aggregating the information in step 217. The newly created WAP page is specific to each user of the system. That is, the mobile gateway is capable of aggregating and formatting the information, coupon, and options from retailers 117a-117n and coupon issuers 119a-119m into a format that is easily viewed on the screen of mobile device. The WAP page, list of options, and/or detailed information is then displayed on the screen of the mobile device in step 219. The user utilizes the list of retailers/coupon coupon issuers or option menu to choose a desired vendor/coupon coupon issuer in step 221. The user is then connected directly to the selected vendor or coupon issuer. The user can also utilize the WAP page to perform such actions as viewing a multimedia clip, purchasing the item related to the scanned barcode, etc.

The mobile gateway is also capable of saving the barcodes that a user scans in user database 113. These barcodes can then be accessed at a later time by mobile device 101 or by workstation 121. If a user elects to utilize workstation 121, the user will be able to access the same coupon using the stored barcodes that the user was able to access utilizing mobile device 101. For example, a user could utilize workstation 121 to purchase an item related to a barcode previously scanned by mobile device 101.

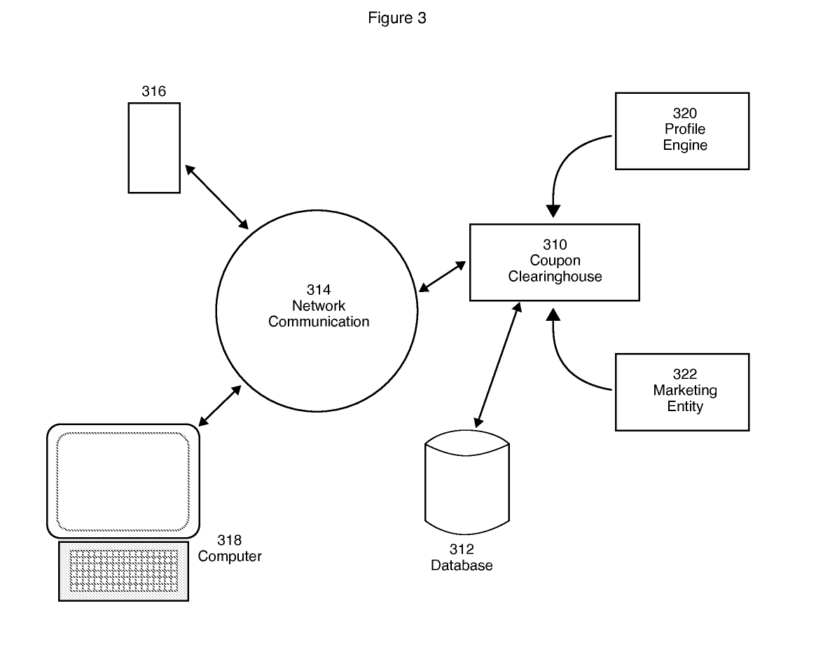

Referring to FIG. 3, a schematic block diagram illustrates an example of a retail coupon distribution system 300. The retail coupon distribution system 300 includes a coupon clearinghouse 310 for retailers and manufacturers. The coupon clearinghouse 310 contains a database 312 of coupons. Businesses such as retailers and manufacturers arrange for coupon information to be entered into the database 312. Consumers can access the database 312 via network communication 314 using a two-way communication device 316 or computer 318 access. The consumer can search the coupon database 312 from home, business, or using mobile access.

The coupon database 312 can be configured using a profile engine 320. The profile engine 320 sorts coupons into collections based on customer profile. The customer profile is a collection of predicates which identify the type, quantity, or quality of information that is presumed to be desirable to the customer.

Suitable customer profile engines are described in U.S. Pat. No. 6,108,645, entitled “Method and apparatus for efficient profile matching in a large scale webcasting system” to Eichstaedt, M et al., U.S. Pat. No. 6,035,336, entitled “Audio ticker system and method for presenting push information including pre-recorded audio” to Lu, Qi, et al, and U.S. Pat. No. 6,012,051, entitled “Consumer profiling system with analytic decision processor” to Sammon, Jr., T. M., et al, the disclosure of which are hereby incorporated by reference in their entirety.

A marketing entity 322 that may have an association with the coupon clearinghouse 310 delivers coupons to customer subscribers to a coupon service based on the customer profile. The marketing entity 322 delivers the electronic coupons via the network communication 314 to a customer's mobile communication device. Several marketing schemes may be employed by the marketing entity 322. In one example, the service delivers coupons on a regular scheduled basis, for example weekly. In another example, the service delivers coupons when a coupon of interest to the particular customer is made available by a retailer or manufacturer.

In a further example, the service may be granted access by a customer to location information regarding the customer. For example, the customer may activate global positioning system (GPS) locating information that identifies the location of the customer or the customer's two-way communication device. The service may be configured to deliver coupons to a customer when the customer's location is in the vicinity of a retailer that distributes a product that is determined to be of interest to the customer according to the customer profile.

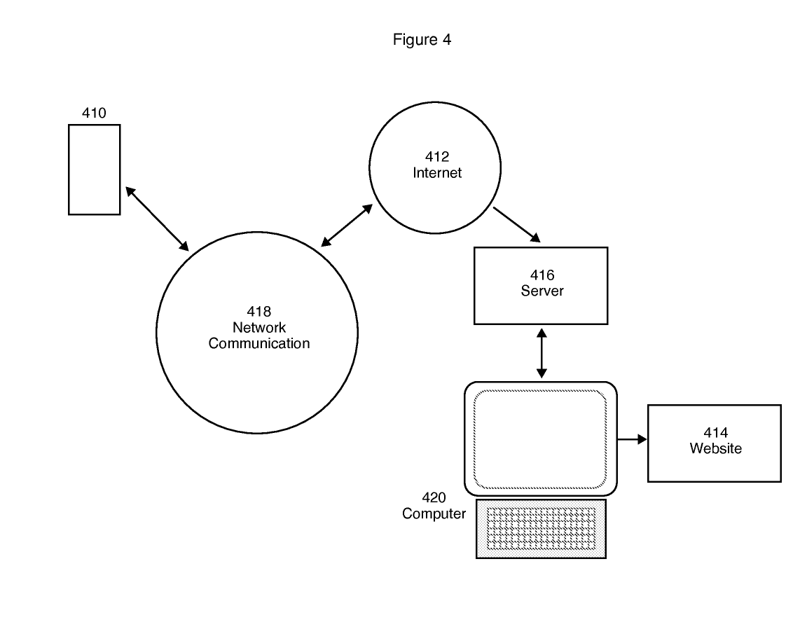

Referring to FIG. 4, a highly schematic block diagram illustrates a mobile communication system 400 that supplies information to a mobile two-way communication device 410 via the Internet 412. The mobile communication system 400 supports two-way communication between the mobile device 410 and a web site 414 made available via the Internet 412. Companies that supply services and information via the Internet 412 can create mobile web site versions that allow user access on mobile devices such as cellular telephones, palm-held computing devices, pagers, and the like. Mobile web pages typically display text and images with a format and layout that are adapted for receipt and display by a mobile device. The mobile communication system 400 supports various coupon formats such as a Wireless Application Protocol (WAP), HDML, HTML, and Short Message Service Centers (SMS).

The mobile communication system 400 includes a server 416 with wireless communication capabilities, one or more wireless communication devices 410, and a wireless communication network 418 that facilitates communication between a wireless communication device 410 and the server 416. The wireless communication network 418 supports wireless data transport protocols such as Wireless Application Protocol (WAP) and Short Message Service Centers (SMS).

The Server 416 is connected to an application host computer 420 that stores and hosts applications that can be accessed by the wireless communication devices 410. The application host computer 420 supplies system support and maintenance services.

Information coupon that is made available by the application host computer 420 is communicated using SMS or WAP. Information is communicated via the wireless communication network 418 to the wireless communication device 410 and displayed on the wireless communication network 418 so that the user can read information from the screen and store information directly in the receiving wireless communication device 410.

Server 416 receives information coupon from any source and translates the information into an appropriate format and layout for transfer to the two-way communication device 410. The server 416 enables compatibility with legacy communication devices as well as new devices by supporting multiple types of information coupon sources, formats, device from factors, and transport protocols including WAP, HTML, and SMS.

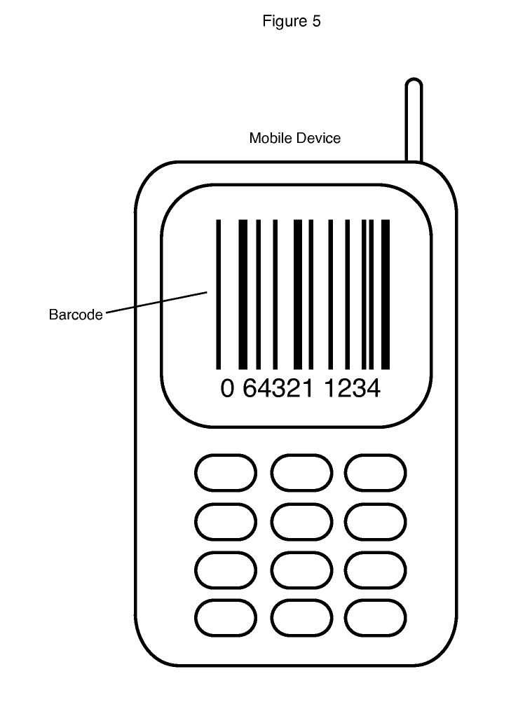

Referring to FIG. 5, a pictorial view shows an example of a cellular telephone screen imposed with a bar-code for usage in various embodiments of the retail distribution apparatus.

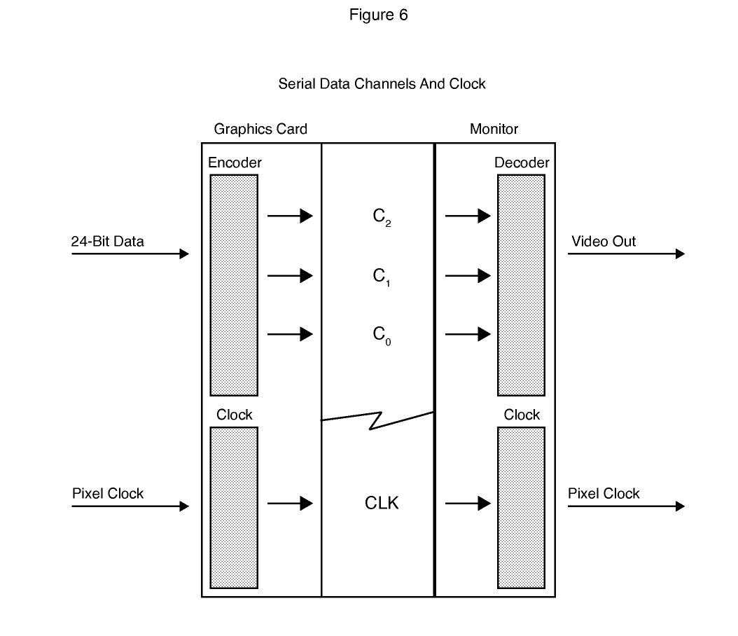

Referring to FIG. 6, a schematic block diagram shows a liquid crystal display (LCD) 600 that is suitable for usage in the retail distribution system. The LCD display operates by altering the light transmissive properties of a field of liquid crystals. An image of a barcode is displayed on the two-way communication device by creating an optical image that can modulate a laser in motion, such as the laser used in a retail barcode scanning device.

Usage of a machine-readable barcode image on the LCD rather than long human-readable strings of digits enables usage of existing coupon infrastructure without change. Usage of the barcode image on the two-way communication device is more efficient and less cumbersome than usage of paper coupons. The barcode image immediately communicates information concerning the transaction to businesses in the transaction chain, from the retailer to manufacturers. Usage of the barcode image increases the amount of information that can be communicated. A downloaded coupon image can contain additional information to prevent coupon reuse, or tracking of usage.

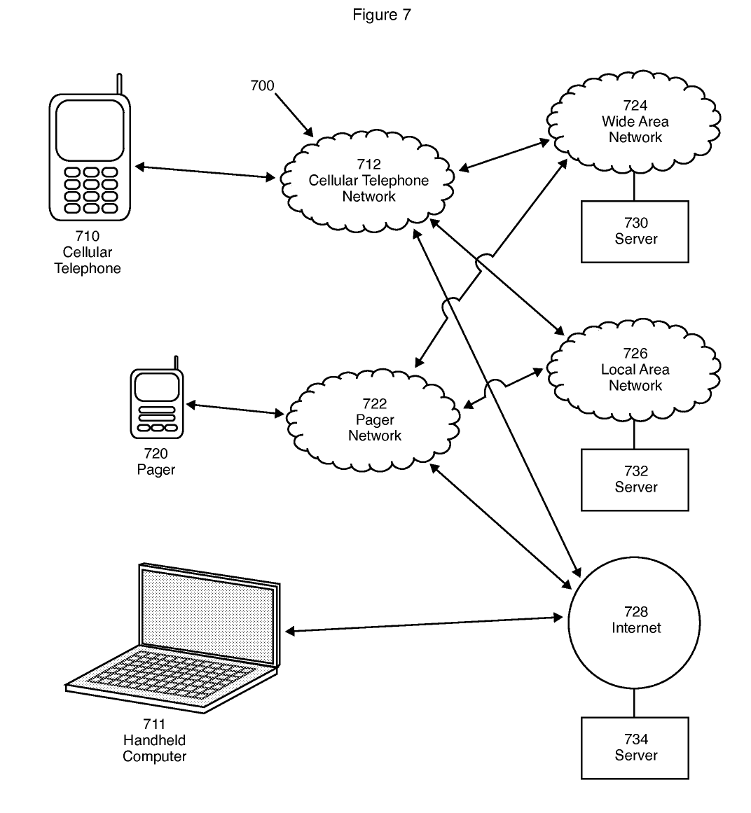

Referring to FIG. 7, a mobile data communication network 700 is capable of interconnecting multiple tow way communication devices, such as cellular telephones 710, palm-held computing devices 711, pagers 720, or the like, with various communication networks.

Two-way data communication devices can be configured to transmit and receive information with selected computers and servers, for example servers 730, 732, and 734, that are connected to various networks such as a wide area network 724, a local area network 726, or an Internet 728. The communication network 700 is a two-way communication path that connects a two-way data communication device to a selected computer or server. The communication network 700 allows a user of the data communication device to activate and engage applications that execute in the selected computer or server.

The cellular telephone 710 or pager 720 can communicate over communication network 700 with any of the servers 730, 732, 734, or others (not shown) that are connected on the communication network 700 and include executable applications that communicate with processes loaded onto the cellular telephone 710 or pager 720. These communications permit the cellular telephone 710 or pager 720 to access information from any computers, servers, and other devices, such as other two-way communication devices, that are connected to the communication network 700. The communications also enable the cellular telephone 710 or pager 720 to supply information to the communication network 700. Similarly, any two-way communication device can be configured to communicate via the communication network 700 with any computers or servers that are connected to the communication network 700 and include any applications that communicate and interact with any processes loaded to the two-way communication device.

Server applications are accessible by any two-way data communication device that has access privileges to the server, independent of the device type and network type. Server applications are accessible to a two-way communications device in any location so long as the device can communicate with the communication network 700.

The two-way communication device, such as cellular telephone 710 or pager 720, includes an internal processor that is capable of executing a client process. Executable applications, called server processes, are capable of executing on servers 724, 726, and 728 connected to the communication network 700 and communicate with the client process.

Internal processors in the servers 730, 732, and 734 typically have higher processing capacity and performance than the size-limited processors internal to the cellular telephone 710 or pager 720. Processing tasks in the communicating device and the servers are typically balanced so that the processing load is more heavily distributed to the processor internal to the server.

The cellular telephone 710 has a telephone keypad and connects to the communication network 500 using a data capable cellular telephone network 712. The two-way pager 720 communicates with an application on one of the servers 730, 732, and 734 through a two-way pager network 722. The cellular telephone network 712 and the pager network 722 connect to the servers 730, 732, and 734 via a network such as the wide area network 724, the local area network 726, the Internet 728, or the like.

A client process in any two-way data communication device is stored as a client module in a memory, such as a nonvolatile memory, within the device. The client process executes various functions that are local to the communication device, including, for example, data display formatting, user interface input signal sensing, server communication packet formatting, receipt of information from the network, and conversion of input and output information.

The cellular telephone 710 or pager 720 has a client module that typically has a small storage capacity and low power consumption. The internal processor of the two-way communication device is typically a low-power circuit so that power consumption of the communicating device is small.

The two-way communication devices, the servers, and the communication network 700 permit a diverse variety of two-way data communication devices to function as open application platforms that allow system developers to create value-added-applications and services to a two-way data communication device. The communication network 700 can expand functionality of communication devices such as cellular telephones 710 or pagers 720 beyond closed, proprietary functionality to an open architecture that allows free creation of new applications and utilizations. New applications for cellular telephones 710 or pagers 720 can be created and implemented for usage by new and existing communication devices without physical modification of the devices. Applications are implemented independent of operating system compatibility constraints.

Hardware and software capabilities of the cellular telephones 710 or pagers 720 typically are fixed at time of manufacture since the devices do not have card slots or disk drives for adding or updating operations. However, the cellular telephones 710 or pagers 720 can be modified or upgraded for new functionality by downloading soft capabilities via communication channels.

To download applications, the client process executing on the cellular telephone 710 or pager 720 functions as an interpreter. A server application executing on any of the servers 730, 732, or 734 supplies information sufficient for the interpreter to generate a user interface on the client communication device. The user interface enables the two-way communication device to send messages and requests to the server. The server receives user selections and input data supplied by the user over the user interface and routes messages to a suitable server of the servers 730, 732, and 734, which may be the server that sent the original information. The client process interprets the received requests and information and controls circuits within the two-way communication device. Applications in the two-way communication device are updated by changes on the server, rather than modifications internal to the device. Accordingly, application software is distributed and implemented at the server level with the cellular telephone 710 or pager 720 exploiting modifications and updates to the applications via communication with the server.

In one example, a cellular telephone 710 or pager 720 can receive a response to a message from an application executing on one of the servers 730, 732, and 734 operating on the wide area network 724, the local area network 726, or Internet 728. An interpreter in the cellular telephone 710 or pager 720 generates a user interface on the display screen of the cellular telephone 710 or pager 720 using information in the message. Typically the display screen is a liquid crystal display (LCD) but other types of display technology may otherwise be used. Selections made via the user interface enable the user to access information or send information to one or more of the wide area network 724, the local area network 726, and the Internet 728.

Once the user interface is operating, the cellular telephone 710 or pager 720 sends a message that is accessed on a computer within one of the servers 730, 732, and 734. The computer responds to the message by executing an application. The application typically includes resource locators for applications that are executable from any computers within the servers 730, 732, and 734. In addition to the resource locators, the application includes common gateway and interface programs, and includes information for generating the user interface. When the user selects and operation or enters data, the interpreter accesses the selected resource locator and sends information to the resource locator to complete a communication link. The client process sends a message that identifies the resource locator to the selected server.

In this manner, applications that are installed on the wide area network 724, the local area network 726, and the Internet 728 send to a cellular telephone 710 or pager 720 sufficient information to generate a user interface and process information received from the cellular telephone 710 or pager 720. New applications can be added at the servers 730, 732, and 734 without any updating of the two-way communication devices.

The cellular telephones 710, pager 720, or other two-way communication devices, include data communication circuits, a multiple-line display screen, storage or memory. Data-capable cellular telephones, telephones that use a cellular digital packet data network, include an internal processor, internal memory and a multi-line display screen, hardware resources that are only rarely used. Additional capabilities enabled by applications installed on the servers 730, 732, and 734 greatly increase the utility of two-way communication devices with little impact on cost, size, and power consumption of the devices. By performing the applications using the processing capabilities and memory that are basic components of a cellular telephone 710 or pager 720, additional capabilities are available without additional costs or increases in size, weight, and battery life of the devices.

Operations of a two-way communication device are similar whether the device is a cellular telephone 710, pager 720, or other type of device.

In response to requests by a user, the cellular telephone 710 or pager 720 transmits a message such as a data request to a server of the servers 730, 732, and 734 on the cellular telephone network 712 or pager network 722. The server responds to the message by sending information to the requesting two-way communication device or, for some applications, by sending information to any specified device in the network. The other specified devices can be other users, such as other cellular telephone 710 or pager 720, or other computers connected to the servers 730, 732, and 734. A cellular telephone 710 or pager 720 can receive a message from any computer connected to communication network 700.

The client process interpreter in cellular telephone 710 or pager 720 generates a user interface that enables the user to both initiate and respond to messages from many different types of applications. Interactions occur in real time. Capabilities are unconstrained by operations of the client process interpreter and are limited only by availability of applications on the connected servers.

Referring to FIG. 7, a cellular telephone user addresses a server to access a desired application or service. Accordingly, various computers or systems that connect to the servers 730, 732, and 734 must have sufficient information to permit communication with a particular cellular telephone 710 or pager 720. In one example, a cellular telephone 710 contacts a central computer over a data-capable cellular telephone network 712. The central computer is connected to multiple networks including the cellular telephone network 712, the pager network 722, one or more wide area networks 724, one or more local area networks 726, and the Internet 728. The cellular telephone user initiates an application by sending a message including a resource locator to the central computer. The central computer processes the message and retrieves information addressed by the resource locator from the appropriate network. After retrieving the requested information, the central computer generates screen images and transmits the screen images to cellular telephone 710. In some embodiments, a single computer is configured to communicate with the cellular telephone 710. In other systems, the computer can be configured to communicate with many or all other computer networks that can communicate with the cellular telephone 710.

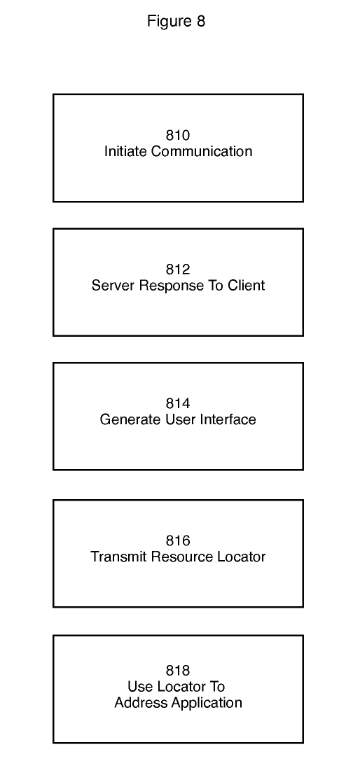

Referring to FIG. 8, a highly schematic flow diagram depicts an example of a communication operation between a two-way communication device such as a cellular telephone 710 or pager 720 and one of the servers 730, 732, and 734. A client process that executes on a processor in the two-way communication device initiates an interaction with a selected server in an initiate communication operation 810. The selected server responds 812 by transmitting information to the client process to generate a user interface 814 and transmitting a resource locator 816 for possible selection by the user. The client process uses the resource locators to address applications 818 on the selected server or other servers, or applications on the selected server that access other servers. Applications that the user can access via the two-way communication device are limited only by the applications provided on the server computers. New or updated applications are supplied by adding or modifying executable modules on the server, without any change to the client process in the two-way communication device. The client process simply interprets information received from a server during execution of an application and transmits messages to request information from the server, client process requirements are unaffected by a new or updated application.

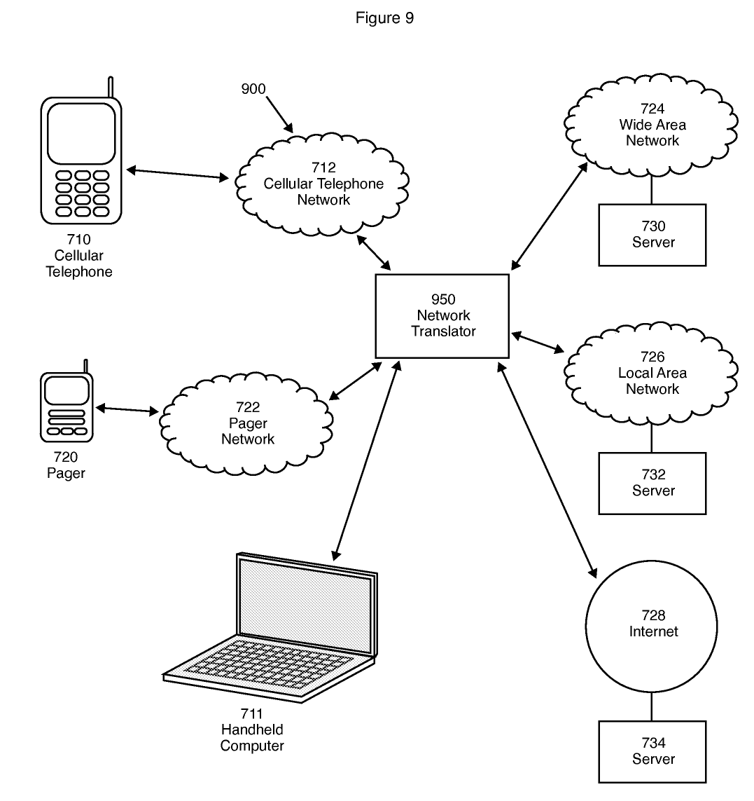

Referring to FIG. 9, a schematic block diagram illustrates another example of a communication network 900. Messages from a two-way data communication device such as cellular telephone 710 or pager 720 are transmitted to a network translator 950. Network translator 950 and the two-way data communication device communicate using a point-to-point communication protocol for a network that links the network translator 950 and the two-way data communication device. A data-capable cellular telephone network 712 is a cellular digital packet data network that communicates either using a transmission control protocol (TCP) or a user datagram protocol (UDP).

Network translator 950 transfers data between the two-way data communication device and the selected computer network after translator 950 validates the communication path and may encrypt the message transferred to the computer network. Network translator 950 accumulates transaction and billing information for communication between the two-way data communication device and the selected computer network. For example, the network translator 950 may control access for paying services, log traffic records for billing purposes, and supply a user directory service.

As an alternative embodiment of accumulating transaction and billing information for verification and expiry of a plurality of electronic coupons, coupon verification is achieved by means of the users pushing a button on their mobile device, including bit not limited to camera phones, laptop or tablet computers, mobile phones, personal digital assistants, smart phones, and cellular telephones, to present said plurality of electronic coupons, which actuates a program in the native application software on the mobile device with interaction with a Internet based computer server that performs a check sum digit calculation, field length verification, date and quantity check.

If the tests are passed, the coupon becomes visible for scanning into the point of sales (POS) terminal by cashier. Cashier scans the phone with POS barcode gun, which currently emits an audible “chirping” sound picked up by the mobile native application software as confirmation of redemption expiry. If the tests are failed, the image is suppressed and a flash message (“non-valid code”) appears on the mobile device display screen. This disclosed alternative embodiment of the present invention will easily work with any POS platform , since the POS system is used as a mere collection point of “clean data” (manufacturer's UPC code, discount amount) previously verified and redeemed in the phone.

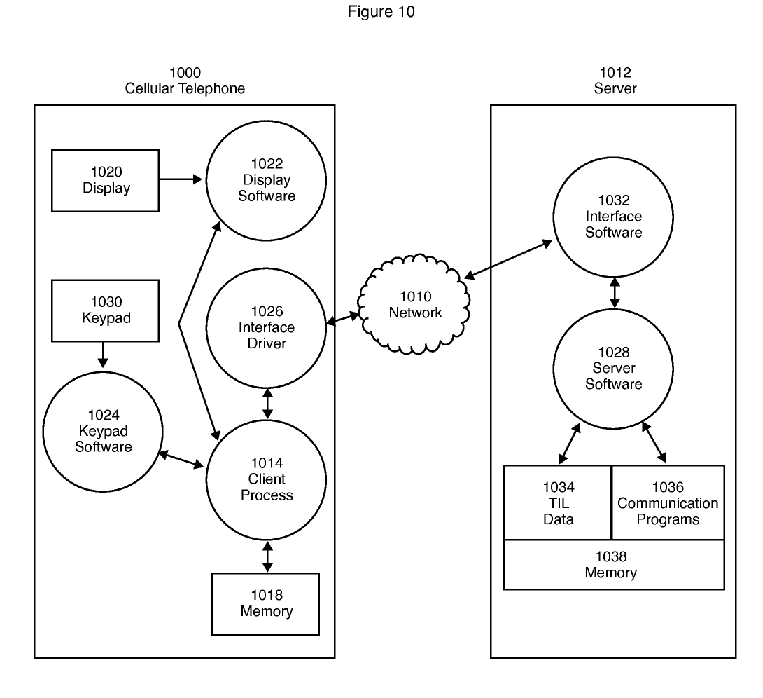

Referring to FIG. 10, a schematic block diagram illustrates an example of components that may be included in a suitable cellular telephone 1000. The cellular telephone 1000 includes circuitry and software that perform voice and data communication operations and modules for operation on network 1010. The cellular telephone 1000 interacts with a server 1012 that includes a processor, storage, and applications software for executing applications on two-way communication devices such as the cellular telephone 1000.

A client process 1014 executes on a processor, such as a microcontroller, within digital cellular telephone 1000. The client process 1014 communicates with server 1012 over a two-way data communication network, for example a cellular digital packet data (CDPD) network 1016. Other suitable two-way data communication networks that are usable by cellular telephones are TDMA, CDMA, and GSM circuit switched data networks, and AMPS analog cellular network for usage with a modem. For a two-way communication device that is a pager, two-way data communication networks include PACT, or other priority two-way paging networks with data transport capability.

The digital cellular telephone 1000 communicates with a server application on server 1012 using telephone interaction description language (PIDL) and terminal interaction language (TIL) information formats. A process encoded in TIL is a compressed version of the same process written in PIDL. TIL facilitates parsing on the two-way data communication device, reducing memory requirements. Compression from PIDL to TIL typically occurs at run time. Compression of PIDL to TIL is highly useful since bandwidth across the cellular telephone network is limited.

Data types are compressed for optimal transfer over the two-way data communication network. For example, verbs in PIDL are compressed using a binary tokenization. Graphics are compressed using run-length-limited compression. Text is compressed using conventional text compression methods. Instructions in PIDL and TIL include information sufficient to generate a screen or a group of screens.

An operation is a related set of actions that are combined in a sequence so that no delay is incurred between actions. The server 1012 stores applications in PIDL language and generates PIDL language modules in response to information or selections made by the cellular telephone 1000.

Server 1012 converts PIDL information to a TIL data and transmits the TIL data to cellular telephone 1000. TIL is configured so that data can be stored unaltered in memory 1018 of cellular telephone 1000 and referenced directly with little or no parsing.

Interactions with a cellular telephone user is directed by information from the user to activate applications that are stored in a server. The user retrieves TIL data stored in a memory 1018 of cellular telephone 1000 after receiving the data from server 1012 over a CDPD network 1016. The user reviews the information in the TIL data and selects options or requests further information based on coupon of the information and the interaction desired by the user.

The cellular telephone 1000 receives data from the server 1012 and displays a first screen of information on a display screen 1020. Screen information typically includes text, an image, or a combination of image and text. The user can respond to the screen, typically by actuating a NEXT key to view the next screen. The user can return to a previous screen by actuating a PREV key, enabling the user to navigate through the screens. While a screen is presented, the user can actuate a scroll key or scroll keys to move the portion of the screen display up and down. Other formatting configurations may be utilized for navigating through informational screens.

In some systems, three types of screen displays are used for two-way communication devices such as cellular telephones or pagers including display screens, select screens, and entry screens. Other systems may use additional types of screen displays. A display screen displays data and images to supply information to the user. A select screen displays a list of options for selection by the user. An entry screen displays one or more lines of text and entry spaces, lines, or selections that enable the user to enter information into the two-way communication device. The entry line can typically receive numeric information, text data, or actuation of a selection from among a group of choices.

In some systems, the choice and entry screens do not allow the user to navigate to a new screen until the user has entered requested information or selections. When the user reaches the last screen and actuates the NEXT key, the client process transmits user data and requests to the server and initiates a request for new information from the server. What information is requested is based on entries made by the user.

Software or firmware for driving the cellular telephone 1000 includes display software 1022, keyboard software 1024, a client process 1014, and UDP interface software 1026. Memory 1018 is a non-volatile memory of cellular telephone 1000 that stores the client process 1014. The client process 1014 executes on a processor, such as a microcontroller, within cellular telephone 1000. Display driver software 1022, keyboard driver software 1024, and interface driver software 1026 operate under the control of the client process 1014.

Client process 1014 includes instructions that control the processor in cellular telephone 1000 to perform application control operations. Operations include sending uniform resource locator (URL) requests to a HyperText Transfer Protocol (HTTP) server 1028, parsing and displaying a TIL deck or decks returned by HTTP server 1028, and generating new URLs based on the user's key presses. HTTP server software and platforms that can run the HTTP server software are described, for example, by Ian S. Graham, The HTML Sourcebook, John Wiley & Sons, Inc., New York, Chapt. 8, (1995), which is incorporated herein by reference.

A user datagram protocol (UDP) interface software 1026 couples CDPD network 1016 to client process 1014, and allows client process 1014 to communicate using UDP over CDPD network 1016. UDP interface module 1026 transmits stand-alone messages between connected devices.

Display software 1022 is a display driver that displays information presented by the client process 1014 on display screen 1020. The client process 1014 operates through the display software 1022 to specify information presented on display screen 1020. User interface manager software in client process 1014 converts display data in the screen information to instructions for display software 1022. The display software 1022 generates signals that drive display hardware and control operation of display screen 1020. For example, if the TIL data includes an image, the user interface manager module determines whether the requested screen contains a display of the image. If the requested screen data directs the user interface manager module to display the image, the user interface manager module passes the image in memory 1018 to display software 1022, displaying the image on display screen 1020.

Client process 1014 controls a keypad 1030 on the two-way communication device via keyboard driver software 1024. Client process 1014 stores data representing keys pressed by the user on physical keypad 1030 in memory 1018. Keyboard driver software 1024 signals client process 1014 when the user has pressed a key. The client process 1014 responds via user interface management software to convey information relating to the key press to display software 1022. The display software 1022 responds by displaying the suitable character on the display screen 1020.

If the displayed screen is a select screen and the user actuates a key that corresponds to one of the choices, then the user interface manager sends instructions to display software 1022 to highlight the selected item.

Software in the server 1012 includes the HTTP server 1028, UPD interface software 1032, CGI programs 1036 stored in a memory 1038 of host server 1012, and TIL data 1034 stored in memory 1038.

HTTP server 1028 uses UPD interface software 1032 to communicate TIL data 1034 with CDPD network 1016. HTTP server 1028 converts static files containing PIDL information to TIL data. HTTP server 1028 uses PIDL information that is produced by common gateway interface (CGI) programs 1036 to produce TIL data. UDP interface software 1040 and 1026 interfaces to cellular telephone network 1016 to transmit TIL data to client process 1014. An application developer can produce an application in PIDL or CGI code to generate PIDL information for storage on server 1012. The application is made available on network 1010 for access by HTTP server 1028 on Internet 728.

The PIDL and CGI code are independent of any particular two-way communication device for a network that supports UDP. Applications on HTTP server 1028 are independent of the particular two-way data communication device in communication in the HTTP server 1028. Applications on HTTP server 1028 can communicate with any two-way data communication device that includes a suitable client process and suitable interface software for connecting to a two-way communication network.

Although the present disclosure describes particular embodiments, other embodiments will be apparent to those of skill in the art. In particular, a user digital information appliance has generally been illustrated as a telecommunications device such as cell phone or personal digital assistant. However, the digital computing device is meant to be any device for interacting with a remote data application, and could include such devices as a personal computer, digitally enabled television, or other system.

Also, channels have been described primarily as traditional phone lines or network connections, with the appropriate corresponding hardware. However, channels are meant to be any channels capable of carrying data, including wireless channels, optical channels, and electrical channels.

Furthermore, while the present disclosure has in some instances been described in terms of client/server application environments, this is not intended to limit the invention to only those logic environments described as client/server. As used herein, “client” is intended to be understood broadly to comprise any logic used to access data from a remote system and “server” is intended to be understood broadly to comprise any logic used to provide data to a remote system.

The invention has been described with a significant amount of particularity, but that one skilled in the art would recognize that some of the features could be used to advantage without the corresponding use of other features which have been described and that many modifications and alterations are possible without departing from the spirit of the invention.

It is understood that the examples and embodiments described herein are for illustrative purposes only and that various modifications or changes in light thereof will be suggested by the teachings herein to persons skilled in the art and are to be included within the spirit and purview of this application and scope of the following claims.

1. A method for providing information associated with a barcode, comprising: receiving barcode information and a user identifier from a mobile device, including, but limited to camera phones, laptop or tablet computers, mobile phones, personal digital assistants, smart phones, and cellular phones ; retrieving first information identifying at least one coupon issuer from a first database based on the user identifier; retrieving second information identifying at least one coupon issuer from a second database based on at least part of the barcode information; selecting at least one coupon issuer based on the first information and the second information; sending the barcode information to the selected at least one coupon issuer; receiving coupon information related to the barcode information from at least coupon issuer; retrieving layout information from the first database based on the user identifier; aggregating the received coupon information to form a WAP page, wherein the layout of the WAP page is based on the retrieved layout information; and sending the WAP page to the mobile device.

2. The method of claim 1, further comprising parsing the barcode information into at least two parts including a manufacturer code, wherein the manufacture code comprises the at least part of the barcode information used in retrieving the second information identifying at least one coupon issuer from the second database.

3. The method of claim 1, further comprising receiving an indication of selected coupon from the mobile device and connecting the mobile device with a coupon issuer associated with the selected coupon.

4. The method as recited in claim 1, further comprising: sending a request to the server from the mobile device for a particular coupon; searching a coupon depository; and forwarding the particular coupon to the mobile device when the particular coupon is stored in the coupon depository.

5. The method as recited in claim 1, further comprising: generating a global positioning signal at the mobile device; reading the global positioning signal; and forwarding a particular coupon to the mobile device based on the global positioning signal.

6. A system for providing information associated with a barcode, comprising: an interface in communication with a network; a memory; and a processor in communication with the memory and the interface; wherein the processor receives barcode information and a user identifier from a mobile device; retrieves first information identifying at least one coupon issuer from a first database based on the user identifier; retrieves second information identifying at least one coupon issuer from a second database based on at least part of the barcode information; selects at least one coupon issuer based on the first information and the second information; sends the barcode information to the selected at least one coupon issuer; receives coupon information related to the barcode information from at least one coupon issuer; retrieves layout information from the first database based on the user identifier; aggregates the received coupon information to form a WAP page, wherein the layout of the WAP page is based on the retrieved layout information; and sends the WAP page to the mobile device.

7. The system of claim 6, wherein the processor further parses the barcode information into at least two parts including a manufacturer code, wherein the manufacture code comprises the at least part of the barcode information used in retrieving the second information identifying at least one coupon issuer from the second database.

8. The system of claim 6, wherein the processor further receives an indication of selected coupon from the mobile device and connects the mobile device with a coupon issuer associated with the selected coupon.

9. The system as recited in claim 6, wherein: the mobile device is a two-way communication device effective to forward a request to the processor for a particular coupon; and the processor is effective to search a coupon depository and forward the particular coupon to the two-way communication device when the particular coupon is stored in the coupon depository.

10. The system as recited in claim 6 wherein the processor is effective to forward a particular coupon to the mobile device based on a user profile.

11. The system as recited in claim 6 wherein: the mobile device further generates a global positioning signal; the processor is effective to read the global positioning signal and to forward a particular coupon to the mobile device based on the global positioning signal.

12. A computer-readable medium containing computer-executable instructions that, when executed by a processor, cause the processor to perform a method for providing information associated with a barcode the method comprising: receiving barcode information and a user identifier from a mobile device; retrieving first information identifying at least one coupon issuer from a first database based on the user identifier; retrieving second information identifying at least one coupon issuer from a second database based on at least part of the barcode information; selecting at least one coupon issuer based on the first information and the second information; sending the barcode information to the selected at least one coupon issuer; receiving coupon information related to the barcode information from at least one coupon issuer; retrieving layout information from the first database based on the user identifier; aggregating the received coupon information to form a WAP page, wherein the layout of the WAP page is based on the retrieved layout information; and sending the WAP page to the mobile device.

13. A computer-readable medium according to claim 12 further comprising: the client process including an operation for initiating a communication with the server process and requesting a first coupon for a selected item; and the server process including an operation for receiving the coupon request, determining whether the first a coupon is available, and, if so, transmitting the first coupon to the client process.

14. A computer-readable medium according to claim 12 further comprising: the client process including an operation for initiating a communication with the server process and requesting coupons for a generic class of items; and the server process including an operation for receiving the coupon request, determining coupons that are available for items in the generic class, and transmitting resultant requested coupons to the client process.

15. A computer-readable medium according to claim 12 further comprising: the server process including an operation for profiling users to determine collections of items of interest to associated classes of users according to user profiles; and the server process including an operation for sending one of the collections of items to one of the users in the associated class.

16. A computer-readable medium according to claim 12 wherein: the barcode includes tracking information for tracking usage of the particular coupon. The barcode type includes , but is not limited to, UPC-A, UPC-E, ISBN, RSS-14, RSS-14E, RSS-14L, Interleaved 2 of 5, EAN/JAN-8, EAN/JAN-13, Code 39 Full ASCII, UPC Code 128, PDF417, QR Code, Data Matrix, and RFID.

17. A computer-readable medium according to claim 12 further comprising: a request process for requesting coupons for a generic class of items; wherein the communication receiving process receives coupon information of one or more coupons for items in the generic class.

18. A computer-readable medium according to claim 12 further comprising: a profile engine coupled to the network and accessible by the server that generates user profiles and creates a collection of coupons according to the user profiles.

19. A computer-readable medium according to claim 12 wherein: the two-way communication device initiates communication with the server and requests a particular coupon for a specific item; and the server determines whether the particular coupon for the specific item is available in the coupon database and, if so, sends the particular coupon to the two-way communication device.

20. A computer-readable medium according to claim 12 further comprising: a profile engine coupled to the network and accessible by the server that generates user profiles and creates a collection of coupons according to the user profiles, wherein the server periodically searches the coupon database for coupons included within the collection of coupons for a particular user profile and sends any resultant coupons in the collection to the two-way communication device.

21. A computer-readable medium according to claim 12 further comprising software for an electronic coupon clearinghouse coupled to a network and containing a plurality of electronic coupons, the electronic coupons including respective encoded barcode images; a coupon database coupled to the electronic coupon clearinghouse; a server coupled to the network, the server capable of accessing the electronic coupon clearinghouse and receiving selected electronic coupons from the electronic coupon clearinghouse; a two-way communication device capable of communicating on the network and receiving electronic coupons from the server via the network, the mobile device capable of decoding the encoded barcode images and displaying the barcode images on a screen display; and wherein the server is responsive to a global positioning signal locating a user position by determining whether the user position is in a vicinity near a retailer honoring a particular coupon in the coupon depository and, if so, sending the particular coupon to the user.

22. A computer-readable medium according to claim 12 further comprising software for interfacing to a retailer point of sale terminal, a plurality of mobile devices and a plurality
